(19) United States
(12) Patent Application Publication
(10) Pub. No.: US 2022/0115982 A1
(43) Pub. Date: Apr. 14, 2022

(54) Autonomous PV Module Array Cleaning Robot

(71) Applicant: William Hammack, Tempe, AZ (US)

(72) Inventor: William Hammack, Tempe, AZ (US)

(21) Appl. No.: 17/478,877

(22) Filed: Sep. 17, 2021

Related U.S. Application Data
(60) Provisional application No. 63/079,778, filed on Sep. 17, 2020.

(51) Int. Cl. H02S 40/10; B25J 11/00; B25J 5/00; B25J 9/16; B25J 9/00

(52) U.S. Cl. CPC H02S 40/10; B25J 11/0085; B25J 9/0009; B25J 9/1664; B25J 9/1694; B25J 5/007

(57) ABSTRACT

Autonomous cleaning robot comprises rear cover and front cover 120. Robot 100 comprises Beale 130. Robot 100 uses two or more, three or more, for more, six or more, or eight or more wheels 130. The exemplar depicted in FIG. 1-a shows the robot with two brush assemblies 140, but the cleaning nature of robot 100 only requires a single brush assembly 140. Assembly 140 comprises brush 150 brush motor 160, and various other components that connect brush assembly 142 chassis of robot 100. Brush assembly 140 connects to the chassis of robot 100 and in some exemplars has two pieces a front chassis 230 and rear chassis 220. Brush motor 160 drives the rotation of brush 150 through a transmission 161.

The present patent application claims priority to Provisional Patent Application No. 63/079,778, filed Sep. 17, 2020, which is incorporated into this document by this reference.

### BACKGROUND TECHNICAL FIELD

The disclosed technology relates to mounting of solar panels using a terrestrial or ground-based mounting system.

### BACKGROUND ART

Solar panels, also called solar modules, are assemblies of multiple photovoltaic (PV) cells hardwired together to form a single unit, typically as a rigid piece, although it is also possible to provide flexible solar panels. Groups of solar panels are aggregated into an array. The panels are also wired together to form a string, which are in turn connected to a power receiving unit, typically an inverter or other controller which provides an initial power output. One or more solar arrays form a solar plant.

A silicon-based photovoltaic (PV) module, also commonly referred to as crystalline silicon (C_Si), is a packaged, connected assembly of typically 6×12 photovoltaic solar cells. For utility scale installations, the solar panels comprise a plurality of solar cells hardwired into a single unit, which is the module or panel. In a typical application, the panel is made up of component solar cells. In the above example of 6×12, this would be 72 solar cells, although this can vary significantly according to design choice. The individual solar cells may be fabricated in any convenient manner, and if desired can be separately fabricated and mounted onto a panel substrate or can be directly fabricated onto the substrate. There are other types of PV module technology in use today such as “thin film” and variations of silicon-based technology.

Of the thin film, at least two module technologies stand out. The first is CdTe (Cadmium Tellurium), also known as CadTel. The second is known as CIGS or CIS (Copper, Indium, Gallium, Selenium or simply Copper, Indium, Selenium).

Several panels are connected to form an array in a procedure called “stringing”. The number of panels making up a string can vary, but in a typical application, this can be 17-29 panels depending on both the environmental condition as well as the rated voltage of the module selected (string voltage). The size of an array is limited by power transmission limitations, including limiting maximum voltage and current at the array. The panels within an array are connected in one or more series and one or more parallel strings. A series string is a set of panels which are series-connected to one another. This increases the power output of the string without a corresponding increase in current, but results in an increase in voltage. Since it is necessary to limit the maximum voltage output of the string as well as the maximum current output of the array, the array is often divided into multiple strings of a common voltage while summing the currents.

The number of panels in a string is given by way of non-limiting example, as this is a function of design considerations relating to panel voltage and related circuit parameters of the strings and arrays.

The arrays are in turn connected to power conversion and power transmission circuitry. This is accomplished by the internal connection of the solar cells within a panel, followed by connections between panels in an array, followed by connections to an inverter either directly or through wiring harnesses. The inverter is the first circuit providing the output of the solar plant. The inverter is connected to further output circuitry, which is connected to transmission circuitry. The details can vary, for example for systems with local power connections, but in most solar power systems, the first connection for power conversion, distribution and transmission is the inverter. In other words, the strings are connected either directly or through wiring harness connections to the inverter.

The disclosed techniques seek to reduce the levelized cost of energy (LCOE) created by modern utility scale solar PV power plants. The utility scale solar PV power plant is unique from the many other forms of solar power electricity production. Due to the nature of the size, energy cost, safety, regulations, and operating requirements of utility scale power production, the components, hardware, design, construction means and methods, operations and maintenance all have both specific and unique features which afford them the designation “utility scale”.

Since the inception of PV technology, the technology has been an inherently expensive solution for power production. The PV cells contained within the heart of the solar modules have been both expensive to manufacture and relatively inefficient. Over the past 40 years, significant strides have been made on all fronts of PV cell and module manufacturing and technology, which have brought their price down to a point which has made the cost of solar based energy generation equal to and even less than all other forms of power generation in certain geographical areas.

When the technology was in its infancy, significant development was directed to handling and positioning the PV cells and their larger assemblies called modules. This development focused on what is now commonly referred to as “dual axis tracking”. This concept seeks to keep the PV cells at perpendicular to the sun's rays—throughout the day and the year. This method sought to extract the maximum energy from the cells to offset the very expensive module cost.

As the price and efficiency of the cells and then modules improved, the costs of dual axis trackers became prohibitive relative to the cost of the panels. This resulted in the development two supplemental technologies now known as “fixed title” racking and “single-axis tracking”. Further developments included adaptation for these newer systems to roof-top mounting on home, office, commercial and industrial buildings. Fixed title and single-axis tracking methods are often categorized as “ground mount” technologies which separate them from the “roof mount” technologies. The ground mount reference is simply that they are not associated with a building rather they are supported by free-standing structures with their own foundations.

Safety and regulatory requirements are generally applied to both secluded solar PV power plants and roof-top systems but are different for utility scale solar photovoltaic power plants than for solar photovoltaic installations which are not in a protected area, as will be described. A utility scale PV power plant typically operates at 1500 volts DC for the module. These modules are not allowed in applications other than utility scale due to the regulatory requirements on the voltage (EMF). Specifically, exceeding 600 volts on the DC side places the system in a category which requires alternative safety, and operating requirements on the system. Examples include requiring a secured fence surrounding the power plant which doesn't allow the public with unfettered access to the higher voltages as well as specific training requirements and certifications for individuals who will be accessing the utility scale solar plant.

The operation of utility scale solar voltaic power plants is distinguished by typical operation at EMF exceeding 600 volts. This is established by several different code requirements, including the (US.) National Electrical Code (NEC), the International Electrotechnical Commission [3] (IEC, or Commission Electrotechnique Internationale), and its affiliates. Electrical connections between enclosures exceeding 600 volts are required to be secured in an enclosure such as a room or fenced area which is restricted to trained or qualified personnel. For the purposes of this disclosure, such an enclosure will be described as a “protected area”. A non-limiting example of such a “protected area” is referenced in NEC Article 110, Part C, which provides the general requirements for over 600-volt applications. There can be variations in the voltage, as it is possible to design arrays that can safely operate at higher voltages in unprotected environments.

These distinctions just two examples of what separate utility scale solar PV power plants from other approaches such as “solar roads”, or “personal use solar power devices”.

As for the continued push to reduce the price of energy from the power plant, for reference, a utility scale solar plant can make electricity in the

Southwestern US at $0.040/kWh as of the beginning 2019. With the same technology in the PV cell's—other than the voltage, a rooftop mounted system will average out to roughly $0.12/kWhr. This is a 3× difference in energy cost using what is essentially the same PV cell technology. The reasons for this drastic reduction in price go far beyond the cell and the module, and in many cases are only allowed to happen inside the utility scale plant.

Solar panels, when deployed, for example in large solar farms, are typically mounted on racks with the racks orienting the panels toward the sun. In the case of gimballed racks, called trackers, the panel is pivoted to face the sun throughout the day, with some systems also accounting for solar elevation or otherwise account for the effect of the sun's analemma. The advantages of fixed racking solar panels and of tracking are of course to increase efficiency, both in establishing an alignment normal to the sunlight and to utilize the physical area of the solar cells more efficiently.

A fixed title rack system typically is positioned at −25° from horizontal, with the angle dependent on various factors including the latitude of the installation site. If a panel is mounted 25° normal to the sunlight, it will convert approximately the same percentage of impinging light, but the amount of impinging light will be the cosine of the angle from normal. Taking the example of 25°, the impinging light is approximately 90% that of a normal alignment, with some additional loss from the fact that the alignment of the solar cells is at an angle to solar light impingement. A tracker will generate 8%-11% more energy than can be expected from fixed rack-mounted panels depending upon geography and array configuration. If the cost of solar panels is relatively high, this loss from misalignment is significant, but as costs of solar panels decreases, the costs resulting from inefficient alignment decreases to an extent that it may be more cost-effective to increase the area of the panel and forego the expense of racking or tracking.

Off the ground, there is no need to sustain ground-caused damage. More generally, the nature of solar cells is such that they are generally waterproof and durable. As an example, it is common for solar modules to be tested and certified to withstand hail of up to 25 mm (one inch) falling at 23 m/sec. While it is possible to clean solar panels, as a practical matter, racked solar panels are not cleaned because the expense is not justified by expected energy loss resulting from dirt and dust accumulation. As an example, in Southern California, estimated energy loss from dirt and dust is 6%/year, but if the panels were cleaned, the loss would approximate 1%/year.

One consideration in mounting solar panels on racks or trackers is the albedo effect, resulting from sunlight reflecting from the ground, resulting in back side heating. This issue is addressed in various ways, the most common of which is coating the back side of the solar panels with a white coating. A common coating for this purpose is a white pigmented Tedlar® PVF, sold by EI duPont de Neumours, of Wilmington, Del. The Tedlar® offers protection, but when pigmented white, reflects most of the back side light. A disadvantage is that, as a white coating, the white pigmented Tedlar® tends to retard heat discharge through the back side.

The voltage output of solar arrays is constrained. Conceptually, a solar array, or for that matter a portion of an entire solar plant, could be series-wired to provide electrical power transmission voltage. In addition, for a need to segment a solar plant for redundancy, maintenance and to avoid arcing to the ground, solar panels are voltage limited by their construction due to the potential of arcing through the glass and backing. In typical configurations, the array output voltage (series voltage of the panels in each string) is 1500 volts, with lower voltages such as 600 volts for residential applications and other applications where untrained personnel are likely to be present. Therefore, conventionally, solar arrays are limited in voltage. To limit the voltage, panels are arranged in groups called strings, which are in turn connected to the inverter through harnesses. It has been necessary to provide harnessing arrangements due to the physical arrangement of the strings on the trackers or racks. In a typical tracker system, three sets of strings are used on a single tracker assembly. To connect those strings to the inverter, harnesses of varying configurations are used, although this number can change according to the length of the rack and other considerations.

The harnesses themselves are a significant cost factor. Since the system is voltage-limited, the total power output of the plant translates to substantial wiring costs for harness systems. Similarly, power losses through the wiring harness translates to additional costs. Therefore, it is desired to provide a configuration which reduces the length of cable runs in connection harnesses.

One wiring harness configuration used with racked modules is called “skip stringing” or “leapfrog wiring”. In skip stringing, wiring harnesses bypass alternate panels to provide efficient wiring by limiting cabling to approximately the distance between alternating modules. The ability to achieve connections extending over a longer distance without a proportional increase in cabling allows positive and negative connections to be placed closer to the inverter, reducing the amount of harness conductors needed to connect to the inverter. Since the panels are alternately connected, the alternate panels within the same physical row can provide a return circuit, thereby reducing the distance between an end panel and the inverter. Ideally, one positive or negative pole connection for connecting the string to the inverter is only one panel away from the other pole connection to the inverter. This reduces the length of the “home run” wire but requires that each link skip alternate panels to return along the same row.

While it would be possible to string panels across two or more rows, doing so would result in shortening of the rows, which increases costs. Skip stringing wiring is used because, by skipping adjacent panels, the length of a given string is maintained while providing for a return connection along the same row. This effectively doubles the length of a string over the length that would exist if the string were extended across two rows.

This system of stringing accommodates the polarities of the panels; however, this technique still requires wiring harnesses in the connection. In addition, these techniques still require additional harnesses to connect between the respective ends of the strings and the inverter. Since adjacent rows of panels are separated by a space corresponding to the cast shadow of racked panels, it becomes impractical to string panels across rows.

Another issue involving rack- or tracker-mounted solar panels is the effect of wind. High wind forces, which in certain geographies reach hurricane force strength, often preclude the construction of solar power plants in those regions, or significantly increase the expense of doing so. In addition, the modules themselves are easily damaged by high winds requiring significant repair and replacement expenditures. In addition to obvious damage resulting from the direct forces of wind, the negative effects of cyclic loading can result in “microcracking”. This “micro-cracking” damage occurs over time causing accelerated degradation rates of the module cells. This micro-cracking has become a serious issue for the industry influencing long-term module warranties.

Another issue involving racked- or tracker-mounted solar panels is the effect of environmental corrosion due to corrosive soils and corrosive air such as salt spray. For example, typical power plants use driven steel piles which are sized as small as possible to counter the effects of wind loading on the overall structure. The design of the piles must consider the corrosion of the steel or other materials, and still be able to last for 25 years. The more corrosive the soil, the thicker the posts will be designed and used as sacrificial steel to ensure the 25-year life. Similar issues exist for geographies near the oceans where salt spray environments exist.

A membrane mounting system for solar panels is described in US Provisional Application No. 2013/0056595 to Tomlinson, which shows a mounting system in which a plurality of standoff mounts is secured to a substrate or membrane in a parallel grid system. Mounting rails are secured onto the standoff mounts, and attachment rails are either secured to opposing side edges of the panels, incorporated into the panels, or incorporated into a supporting carrier for the panels.

### SUMMARY

The disclosed autonomous cleaning robot has two or more wheels; a drive motor connected to at least one wheel; at least one cleaning brush; at least one brush motor connected to the cleaning brush; at least one CPU mounted in or on the chassis (one piece or multiple pieces); and at least one CPU mounted in or on the chassis; and does not use rails or tracks to guide the robot. The autonomous robot is adapted to clean a group of PV modules without real-time human input. Some versions include a drive motor controller connected to the drive motor and a brush motor controller connected to the brush motor. Both of these controllers are under the supervision of the CPU and are connected to the CPU with a signal connection, wired or wireless.

Some versions use at least one sensor mounted in or on the chassis that connects to the CPU with a wired or wireless signal connection. This sensor generates a signal representative of a finite region near the autonomous robot. The computer code running on the CPU can use the signal to control the behavior of the robot without relying on external or human-input during operation. Various types of sensors can be used such as single or combinations of IR, visible, ultraviolet, ultrasonic, sonic, lidar, photoelectric, and inductive sensors. For instance, some versions use two position sensors (sometimes an inductive sensor), an edge detection sensor (sometimes a photoelectric sensor), and two turning sensors (sometimes photoelectric sensors). But other versions may have more or fewer sensors related to these functions or to other functions desired for the robot.

Related methods are also disclosed. For instance, disclosed methods have steps of providing an autonomous robot as described. The robot is placed on onto a first group of PV modules not having robot rails or tracks and cleaning is initiated. After that cleaning completes without real-time human input. The methods also include steps of the robot crossing a significant gap to additional PV-module groups for cleaning those groups, again without real-time human input.

In some methods, the robot stores the number of columns and the number of rows of the first group, and when needed the second group, in computer memory connected to the robots CPU. The CPU propels the robot along the first row, slows the robot near an end of the row and analyzes the edge detector signal to ascertain the border of the last module in the row and the material adjacent it. At that point, the CPU stops the robot at the sensed border.

Next, the CPU turns the robot onto a second row; and propels the robot along the second row.

### BRIEF DESCRIPTION OF THE DRAWINGS

FIG. 1 depicts a perspective view of an autonomous cleaning robot.

FIG. 2 depicts a front view of an autonomous cleaning robot.

FIG. 3 depicts a rear view of an autonomous cleaning robot.

FIG. 4 depicts a left-side view of an autonomous cleaning robot.

FIG. 5 depicts a right-side view of an autonomous cleaning robot.

FIG. 6 depicts a top view of an autonomous cleaning robot.

FIG. 7 depicts a bottom view of an autonomous cleaning robot.

FIG. 8 depicts a perspective view of an autonomous cleaning robot.

FIG. 9 depicts a bottom perspective view of an autonomous cleaning robot.

FIG. 10 depicts a perspective view of an autonomous cleaning robot.

FIG. 11 depicts a block diagram of an electronic assembly of an autonomous cleaning robot.

### DETAILED DESCRIPTION

### Overview

The disclosed technology provides a technique for generating electricity using either commercially available, utility scale, solar PV (e.g., CSi, CdTe, CIGS, CIS) modules, or new and novel adaptations of commercially available, utility scale, solar PV modules, or new module technologies, a plurality of which are mounted in such a way as to be both in direct contact with the earth's surface and parallel to the same. This establishes an earth orientation of the solar PV modules, as distinguished from a solar orientation, although contouring of the soil and other mounting considerations will consider the angle of the sun.

The modules are placed in a grid pattern both edge to edge and end to end as if tiles on the floor of a house. The “utility scale” nature of the modules limits the application of said system to voltages exceeding 600 volts DC which ensures the system is placed “behind the fence” whereby limiting access to trained professionals. There can be variations in the threshold voltage, as it is possible to design arrays that can safely operate at higher voltages in unprotected environments, a non-limiting example being 800-volt arrays for unprotected areas. The method of attachment of the modules to one another or to the earth is not limited by this application. This arrangement of modules substantially reduces wind loading effects of the modules. The arrangement of the modules electrically is in such a way as to allow for both series and parallel connections, and eliminates, but does not preclude the need for discrete wiring harnesses and harness supporting means used by traditional utility scale solar plant PV power plant systems. This arrangement of modules provides for significant advantages with the use of commercially available string/micro inverters but does not preclude the use of industry standard central inverters or alternate power conversion and transmission technologies.

This arrangement of modules in conjunction with the use of active electrical protective devices such as ground fault interruption and arc fault interruption, fully eliminates the need and subsequent use of electrical grounding and bonding of the modules to the structure for purposes of personal protection per code compliance. In contrast, these devices, when used in conjunction with conductive module support structures do not meet the protection levels necessary for code compliance, and thusly require the use of bonding and grounding of the modules.

This arrangement of modules fully eliminates the need and subsequent use of steel and steel structures in the power plant thereby reducing and/or eliminating the natural weathering effects of corrosion while enhancing life expectancy of the power plant from a minimum requirement of 25 years to greater than 40 years. This system does not preclude the use of steel, coated or otherwise for site-specific applications.

The arrangement of modules allows for both commercially available and new techniques for module cleaning and/or dust removal from the modules surface, increasing the effective energy production rate of the modules.

The arrangement of modules and disclosed technology significantly reduce the negative effects of high wind forces on the modules. These wind forces, which in certain geographies reach hurricane force strength, often preclude the construction of solar power plants in those regions, or significantly increase the expense of doing so. In addition, the modules themselves are easily damaged by high winds requiring significant repair and replacement expenditures. By removing the modules from the direct forces of wind, the negative effects of cyclic loading, the “micro-cracking” is effectively eliminated.

The disclosed technology allows for both commercially available and new or novel methods for module cooling from the backside of the modules' surface including evaporative cooling, alternate high emissivity coatings, the addition of “air vents” on the edge of the module frame, the addition of various enhanced heat transfer materials and/or methods, thereby increasing the effective energy production rate of the modules.

The positioning of the modules on the ground results in avoiding indirect sunlight and heat from ground exposed to sunlight from heating the backsides of the modules. As a result, rather than being a source of additional heat, the ground beneath the modules becomes more of a heat sink. To take further advantage of this, the modules are coated on the backside with a dark or heat transmitting coating to promote radiant heat transfer to the ground or airspace beneath the modules.

The disclosed technology increases the power density per acre of land. The quantity of acres used per unit of power production is reduced by more than 50% from traditional utility scale solar plant PV power plants.

The disclosed technology allows the PV array to follow the existing contour of the land whereby the need for land preparation such as mass grading, plowing, tilling, cutting, and filling as is typically needed for utility scale solar plant PV power plants can be significantly reduced and even eliminated.

The disclosed technology inherently results in an effective decrease in annual module performance yield as measured in kWhrs per kWp as compared to traditional solar PV power plant systems because of not being oriented to the sun as are the trackers and racks. While the energy performance is significantly reduced, the reductions in electrical losses due to wiring, energy losses due to module cleaning, costs materials and construction, construction schedule and risk result in an overall reduction in produced energy price (LCOE) of greater than 10% over current technologies.

The disclosed technology provides a system for a solar PV module directly mounted to the earth. In one non-limiting configuration, a bracket assembly utilizes the module frame as the structural support system by securing the four corners of the solar PV module frame directly to the earth leaving no air gap between the earth, frame corners, and bracket assembly. Earth mounting with no air gap reduces wind loading and uplift forces, and eliminates shading from panel to panel, has zero or minimal row spacing requirement, and increases the ground coverage ratio. This earth mounted PV system orients the PV panels parallel to existing topography and the solar panel arrays can be positioned at any azimuth angle.

Solar panels, sometimes called solar modules, are configured as tiles suitable for installation directly on the earth and are configured to take advantage of the cooling and heat sinking effects of the earth. In placing the panels, attachment brackets may be used. The panels are snapped into or otherwise secured to the attachment brackets, retaining a solar array on the ground or near the ground. The ground placement allows a low-cost configuration in that it avoids the requirements for mounting the panels on racks and avoids shadows and the consequential need for spacing between rows.

Since the panels are not mounted on racks, the requirements for wind tolerance are significantly reduced. This also reduces the need to anchor the panels because there are no racks to mount, and since the panels are on the ground, there is substantially less lifting due to wind conditions.

The mounting may use attachment brackets which connect adjacent panels together. While it is possible to anchor the brackets to the ground, the anchoring requirements, meaning anchoring force, is greatly reduced because the panels are not supported above-ground in the wind at an angle to the horizontal. Instead, the panels rest substantially flat on the ground or near the ground.

The brackets secure the panels to each other and maintain a fixed positioning of the panels to stabilize the panels in a desired position. Anchor stakes augment this stability but need only secure the panels against forces experienced when laid flat on the ground, which is substantially lower than the force incurred in rack-mounted or tracker mounted configurations.

The lack of shadows is in part the effect of the panels not being tilted. This results in reduced power conversion as compared to panels oriented toward the sun, but if the total costs of the array without racks compares favorably with the loss of output from flat placement, flat placement can be cost-effective.

The lack of shadowing between adjacent rows of panels falls into this economic balance. The reason there is no shadowing is that the shadowing is created by the racking, and more specifically, from the angled positioning of the racked panels. Since racking is not used, there is no shadowing, which allows configurations which close the gaps between sequential rows. Elimination of the gaps establishes a two-dimensional connection array, meaning closely adjacent panels extend in a row-wise direction as well as across sequential rows because sequential rows are also adjacently positioned. In other words, gaps between sequential panels from row-to-row closely approximate gaps between sequential panels along the rows.
PV module 10
Autonomous cleaning robot 100
rear cover 110
front cover 120
Wheel 130
brush assembly 140
brush 150
brush motor 160
transmission 161
Battery 210
rear chassis 220
front chassis 230
Sensor 240
sensor mount 250
electronic assembly 260
edge detector 280
drive motor 310
pivot shaft 320
photoelectric sensor 330
photoelectric sensor mount 340
CPU 2200
power system 2210
navigation system 2310
communication system 2410

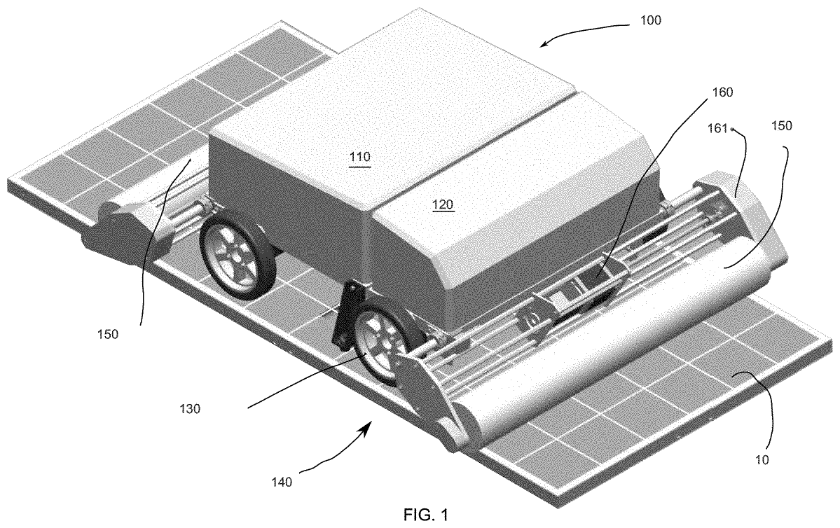

FIG. 1 depicts an autonomous cleaning robot 100 according to the current disclosure. Autonomous cleaning robot 100 comprises rear cover 110 and front cover 120. Robot 100 comprises Beale 130. Depending upon the exemplar, robot 100 uses two or more, three or more, for more, six or more, or eight or more wheels 130. The exemplar depicted in FIG. 1 shows the robot with two brush assemblies 140, but the cleaning nature of robot 100 only requires a single brush assembly 140. Assembly 140 comprises brush 150 brush motor 160, and various other components that connect brush assembly 142 chassis of robot 100. Brush assembly 140 connects to the chassis of robot 100 and in some exemplars has two pieces a front chassis 230 and rear chassis 220. Brush motor 160 drives the rotation of brush 150 through a transmission 161.

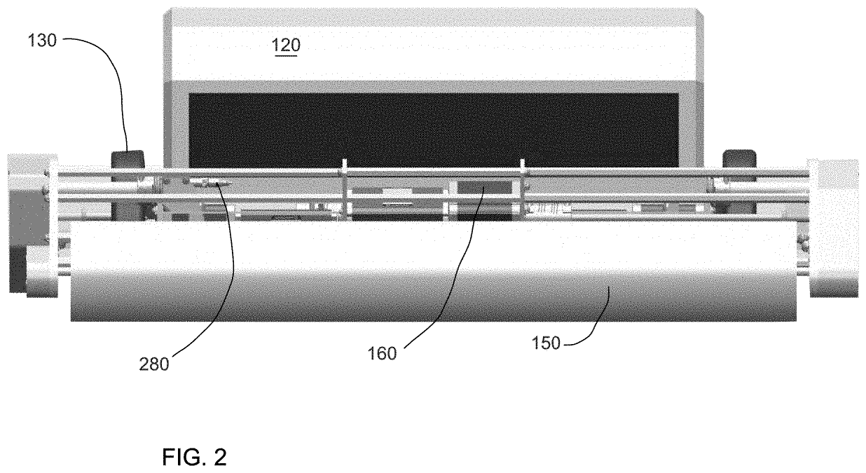

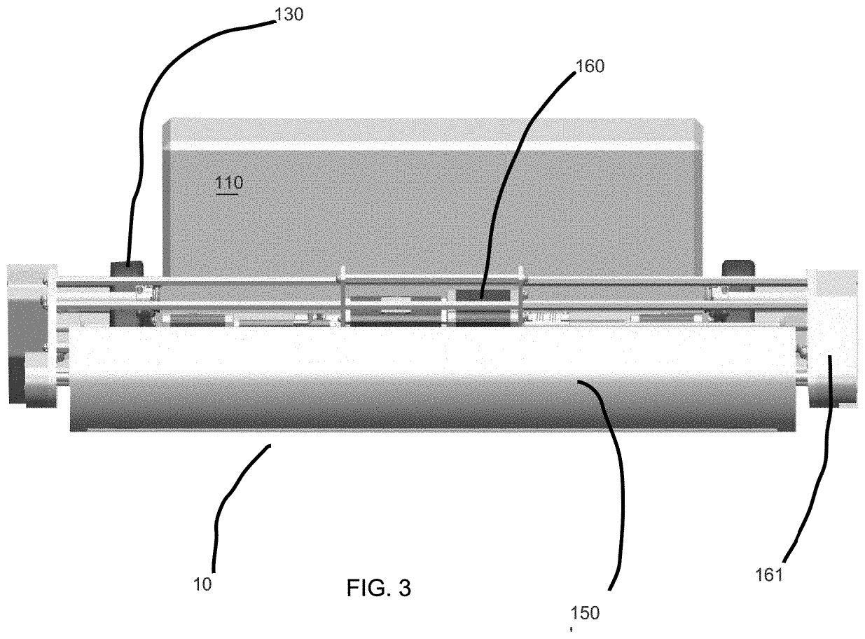

FIG. 2 depicts a view of the robot 100 sighting directly at the front, directly at brush 150. As identified previously, the figure depicts wheels 130, front cover 120, and brush motor 160. FIG. 2 also depicts edge detector 280. Additionally, FIG. 3, as it depicts a view of the robot 100 sighting directly at the back, directly at brush 150′.

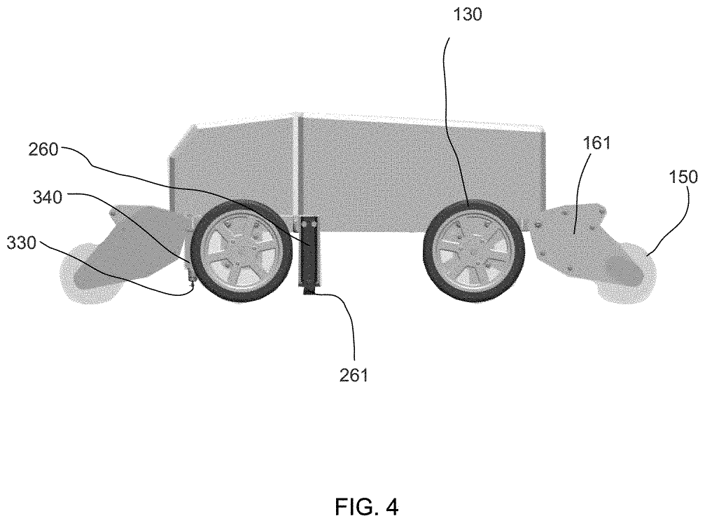

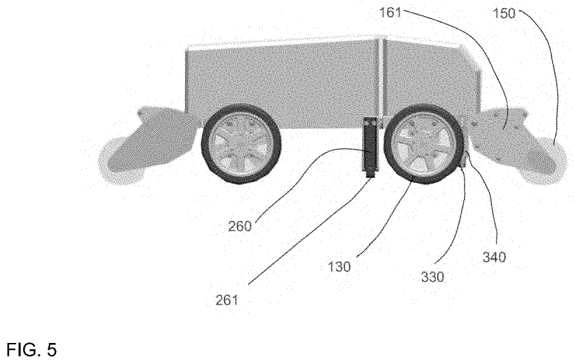

FIG. 4 and FIG. 5 depict right- and left-side views of the robot 100. In addition, to previously identified rear cover 110, front cover 120, wheel 130, brush assembly 140, brush 150, and PV module 10, the figure shows sensor 240, sensor mount 250, photoelectric (PE) sensor 330, and PE sensor mount 340.

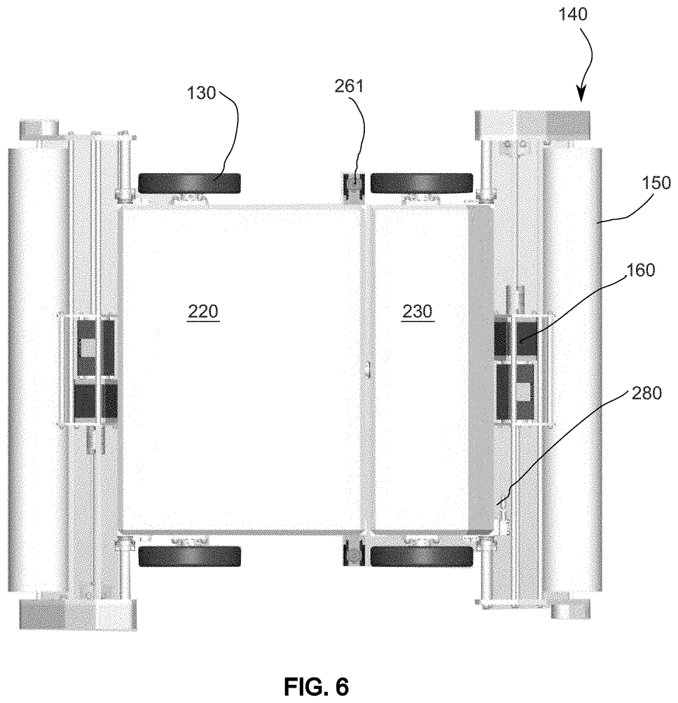

FIG. 6 depicts a top view of robot 100.

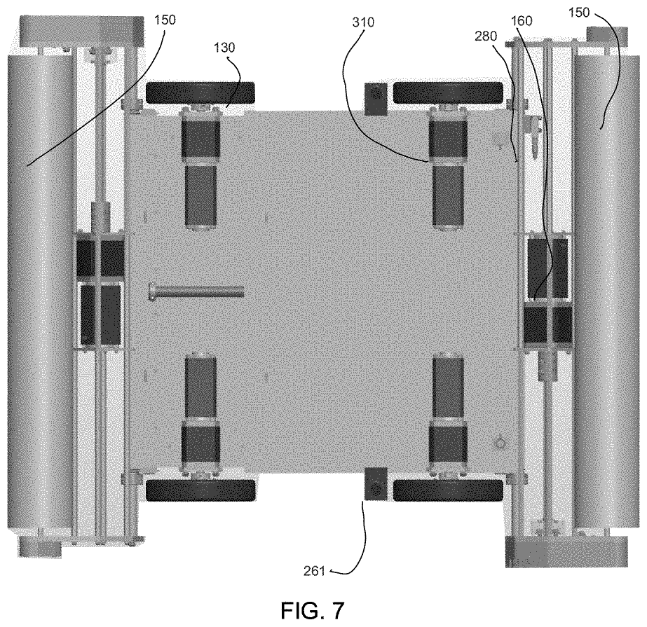

FIG. 7 depicts a bottom view of robot 100.

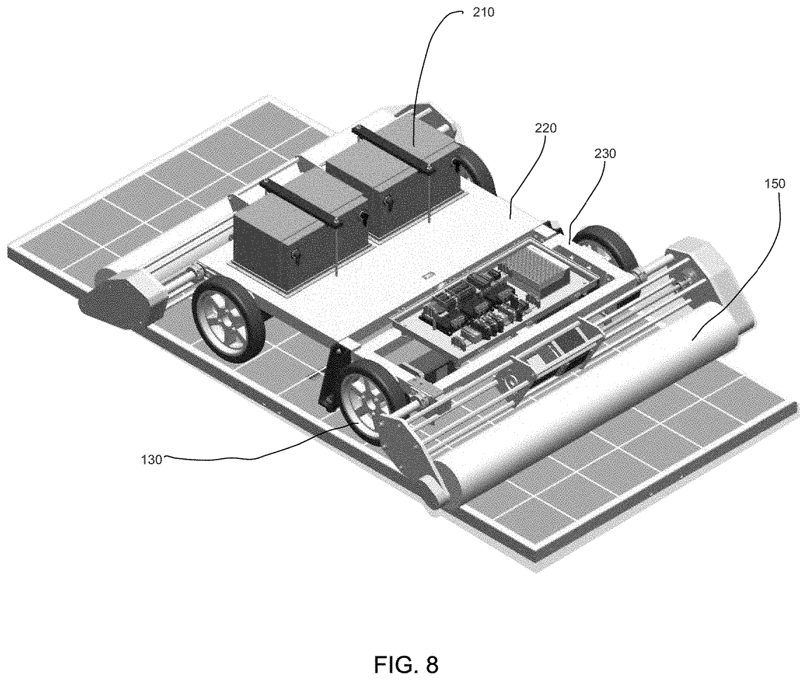

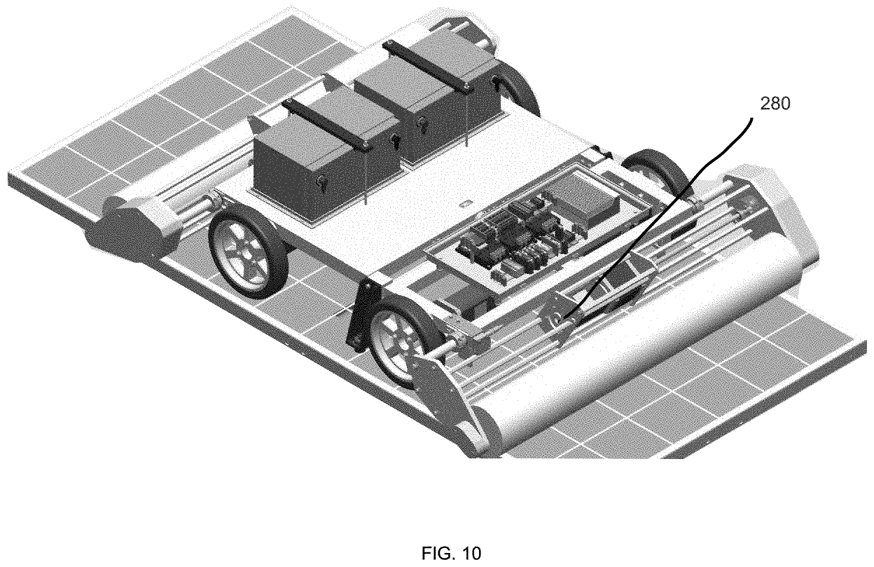

FIG. 8 depicts a perspective view of robot 100 sitting on PV module 10. As shown, robot 100 has wheels 130, brush assembly 140, brush 150, battery 210, rear chassis 220, front chassis 230, and electronic assembly 260. FIG. 10 shows a similar perspective view of robot 100, but in this figure a component of brush assembly 140 removed to better show edge detector 280.

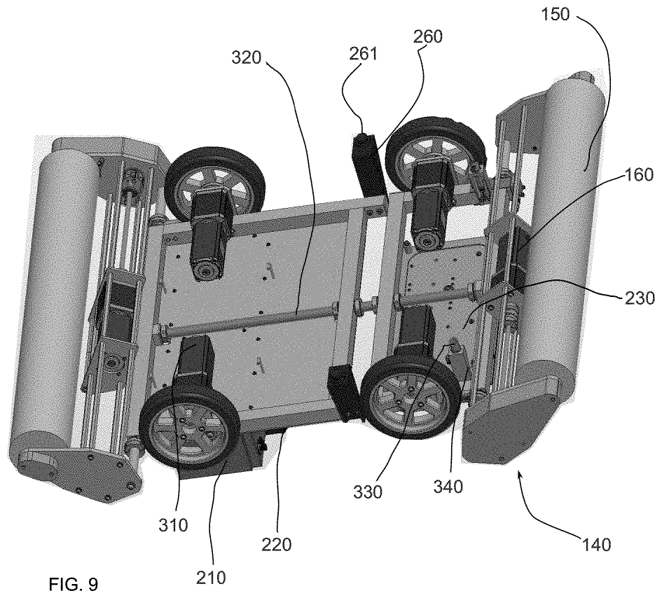

FIG. 9 further shows pivot shaft 320.

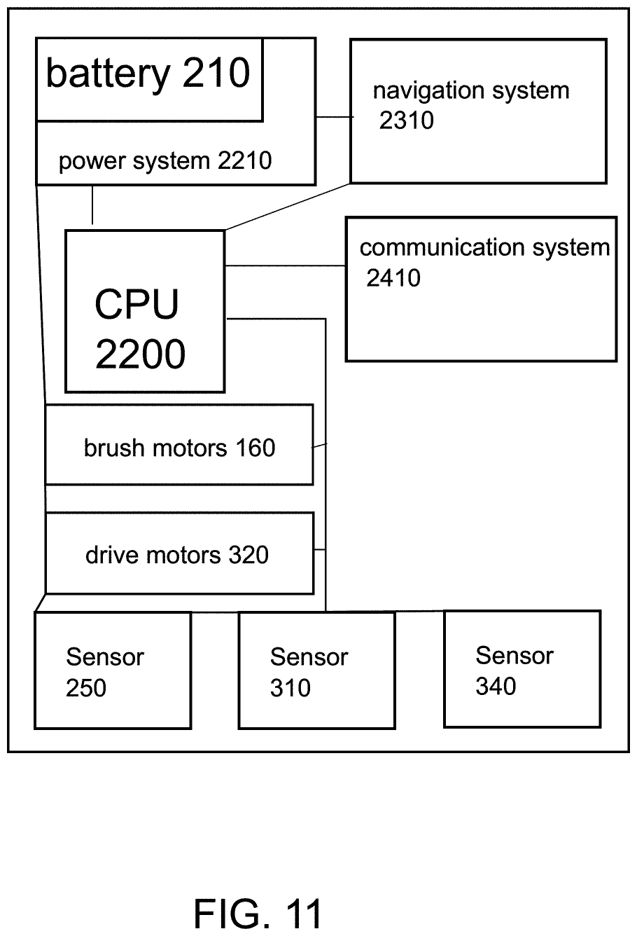

FIG. 11 depicts a block diagram of the electronic assembly 260 of autonomous cleaning robot 100.

Some exemplars have a flat array, continuous array, contiguous array, and not having a “significant” gap from module-to-module or array-to-array of PV modules, which simplifies employing autonomous cleaning robot 100 for array cleaning. For this disclosure, a significant gap can be crossed only by a wheel or track of the robot touching the ground or with external assistance or external human assistance.

In some exemplars, the autonomous cleaning robot 100 can cross an area with 500 modules without coming off the modules' surface. This continuous surface is called an Island (a composition of arrays of a solar site surrounded by a leading edge). This area differs from that of a Fixed Tilt (FT) or Single Axis Tracker (SAT), etc. In such systems, a robot can only cross one row of modules (typically three strings—up to 84 modules) in a series or row because the gap between rows of SAT or FT systems is significant.

Autonomous cleaning robot 100 performs on a surface without a significant gap from panel to panel, enlarging the total cleaning surface area for a single robot compared to typical SAT or FT. SAT or FT systems require additional robots or physically moving robots between rows of panels.

Autonomous cleaning robot 100 crosses marked vertical height differences between neighboring panels without reducing the cleaning contact area of individual panels.

Autonomous cleaning robot 100 cleans in dry and wet conditions with standing water on top of the modules. A flat module will have at least 0.25 in of standing water after significant rain (depth due to frame rail height of module). The autonomous cleaning robots use available rainwater as a cleaning medium in various examples. Sometimes, the autonomous cleaning robots harvest rainwater as it is swept off the panels. Other times, the water isn't harvested. But in water-harvested exemplars or not, the water helps clean the panels when it is available. No autonomous cleaning robot exemplars require additional water.

Cleaning brush assemblies use wheels at the ends of the brushes to cross over vertical module-to-module gaps so brushes do not get stuck or damaged when encountering a vertical gap. Instead, the wheels follow the profile of the modules and their respective vertical elevations.

In some exemplars, the brush wheel ends create a fixed height difference between the bristle ends and the module, fixing the brush's pressure on the module.

Autonomous cleaning robot 100 can turn using omni wheels without issue.

In some exemplars, the autonomous cleaning robot 100 chassis swings on a pivot shaft between the right side and left side of the chassis to cross bumpy terrain while keeping either or all of the respective front, middle, and rear brushes tangent to the module surface. The robot's left side controls the front brush while the right side controls the back brush, and these brushes can independently sit on different planes to match module surfaces on different planes.

In some exemplars, the autonomous cleaning robot 100 chassis swings on a pivot shaft between the front and back of the chassis to cross bumpy terrain while keeping either or all of the respective front, middle, and rear brushes on the module surface. The pivot shaft allows these brushes to sit on different planes independently to match unaligned module surfaces.

In some exemplars, the autonomous cleaning robot 100 uses an ‘independent front suspension’, which maintains the brush's rotation axis parallel to the module surface to maintain maximum cleaning ability. For example, if the robot faces North and the module tilts 5 degrees to the west, the brush will follow the 5-degree tilt to maintain contact with the module surface.

In some exemplars, the autonomous cleaning robot 100 provides these benefits for an Earth Mounted solar array/plant:
Reduction of electric generating losses from the DC module arrays through frequent cleaning. Cleaning can be done once daily in some exemplars. Sometimes the losses are less than 0. 1-10%, 1-5%, or 0.1-5%
Real-time data to plant SCADA system for preventive maintenance
a Primary Control Station, which could include infrared and thermal module imaging and Artificial Intelligence scanning or imaging of module soiling
Cutting, mowing, or removal of organics that may grow over modules
Central control of robot system from SCADA HMI or centralized operations management through remote control methods or means
Performance data capture for both individual robot health and DC array health

Depending on the exemplar, this autonomous cleaning robot system exhibits these characteristics:
Autonomous operation for cleaning, docking, and stowing to provide lifetime array cleaning
Wireless communication throughout the entire system while maintaining data security and integrity Sensor integration of numerous sensor types of sensors to enable autonomous operation
Robot Docking Station provides automatic battery charging and weather protection for all cleaning robots
Variable brush configurations including 2-3 brushes employed on an individual robot; Bi-Directional rotation of brushes for cleaning and maneuvering; and variable speed brushes for various soiling conditions found in different geographical locations
Cleaning speeds of many megawatts per day per individual autonomous cleaning robot 100
Module adaptability such that autonomous cleaning robot 100 can adjust to varying module dimensions from numerous module manufacturers
Autonomous cleaning robot 100 is not hindered by wet and dry conditions Cleaning path optimization through programmable machine learning
Using a microchip in the junction box of a solar module, the robot's on-board computer will read the DC health of the solar module (where the junction box and microchip is located) as it traverses over the top of the surface of the solar panel. This information will then be fed into the central controlling system of the solar plant's control in order to gain inferences on DC health of the plant and provide preventative maintenance and Operations and Maintenance measures.

What is claimed is:

1. An autonomous robot comprising:
two or more wheels;
a drive motor connected to at least one wheel;
at least one cleaning brush;
at least one brush motor connected to the cleaning brush;
at least one CPU mounted in or on the chassis; and
at least one CPU mounted in or on the chassis; and
not containing rails or tracks,
wherein the autonomous robot is adapted to clean a group of PV modules without real-time human input.

2. The autonomous robot of claim 1 further comprising:
a drive motor controller connected to the drive motor and in signal connection with the CPU; and
a brush motor controller connected to the brush motor and in signal connection with the CPU.

3. The autonomous robot of claim 2 further comprising:
at least one sensor mounted in or on the chassis and in signal connection with the CPU.

4. The autonomous robot of claim 3 wherein at least one sensor is adapted to generate a signal representative of a finite region near the autonomous robot.

5. The autonomous robot of claim 4 wherein at least one sensor is any one or any combination of IR, visible, ultraviolet, ultrasonic, sonic, lidar, photoelectric, and inductive sensors.

6. The autonomous robot of claim 5 wherein a first of the at least one sensors is a first position sensor.

7. The autonomous robot of claim 6 wherein a second of the at least one sensor is a first edge detection sensor.

8. The autonomous robot of claim 7 wherein a third of the at least one sensors is a first turning sensor.

9. The autonomous robot of claim 8 wherein a fourth of the at least one sensor is a second position sensor.

10. The autonomous robot of claim 9 wherein a fifth of the at least one sensor is a second turning sensor.

11. The autonomous robot of claim 10 wherein the chassis comprises two pieces.

12. The autonomous robot of claim 11 wherein at least one of the first and second position sensors is an inductive sensor.

13. The autonomous robot of claim 12 wherein at least one of the first and second turning sensors are photoelectric turning sensors.

14. The autonomous robot of claim 13 wherein the edge detection sensor is a photoelectric sensor tuned for concrete.

15. The autonomous robot of claim 14 wherein the inductive sensor is tuned to detect the surface of a PV module not an aluminum frame of a PV module.

16. A method comprising:
providing an autonomous robot having:
two or more wheels;
a drive motor connected to at least one wheel;
at least one cleaning brush;
and
at least one brush motor connected to the cleaning brush;
placing the robot on a first group of PV modules not having robot rails or tracks;
and
cleaning the first group without real-time human input.

17. The method of claim 16 further comprising:
a bridge crossing step wherein the robot crosses a bridge over a significant gap without real-time human input to a second group of PV modules not having robot rails or tracks;
and
cleaning the second group of PV modules without real-time human input.

18. The method of claim 17 wherein the providing an autonomous robot step comprises storing the number of columns and the number of rows of the first group in computer memory connected to a CPU composing the robot.

19. The method of claim 18 wherein the cleaning the first group step comprises the CPU without external input:
propelling the robot along a first row;
slowing the robot near an end of the first row;
using an edge detector to sense border material adjacent the end of the first row;
stopping the robot at the sensed border;
turning the robot onto a second row;
and
propelling the robot along the second row.

20. The method of claim 19 wherein the propelling steps comprise the CPU without external input:
sensing a first-position-sensor voltage;
sensing a second-position-sensor voltage;
subtracting the first-position-sensor voltage from the second-position-sensor voltage to calculate a value;
and
adjusting the rotational speed of the drive motor proportionally to the value.
